(19) United States
(12) Patent Application Publication
(10) Pub. No.: US 2011/0120431 A1
(43) Pub. Date: May 26, 2011

(54) Exhaust Gas Recirculation Valve Actuator

(76) Inventor: Daryl A. Lilly, Winterset, IA (US)

(21) Appl. No.: 13/003,354

(22) PCT Filed: Jul. 9, 2009
(86) PCT No.: PCT/US09/50065

§ 371 Date: Jan. 10, 2011

Related U.S. Application Data
(60) Provisional application No. 61/079,680, filed on Jul. 10, 2008.

(51) Int. Cl. F02M 25/07; F01N 13/00; F02B 37/00

(52) U.S. Cl. 123/568.12; 60/324; 60/605.2

(57) ABSTRACT

An EGR system for an engine that includes an exhaust gas recirculation conduit in fluid communication with an exhaust line and an intake port is provided. A cooler is fluidly positioned along the exhaust gas recirculation conduit and in fluid communication with the exhaust line and the intake port. A valve is fluidly positioned along the exhaust gas recirculation conduit and in fluid communication with the exhaust line and the intake port. The valve includes an electronic solenoid controlled hydraulic actuator operable to control the valve, and the actuator includes a position feedback sensor to detect a position of the valve.

### CROSS-REFERENCE TO RELATED APPLICATION

This application claims the benefit of U.S. Provisional Patent Application No. 61/079,680 filed Jul. 10, 2008, the disclosure of which is hereby incorporated by reference in its entirety.

### STATEMENT CONCERNING FEDERALLY SPONSORED RESEARCH OR DEVELOPMENT

Not applicable.

### FIELD OF THE INVENTION

The present invention relates to valves for exhaust gas recirculation (EGR) systems, and in particular to such a valve that is a solenoid controlled valve.

### BACKGROUND OF THE INVENTION

Exhaust gas recirculation (EGR) systems have become popular to assist vehicles in meeting emission requirements. EGR systems achieve this by diverting a portion or all of the exhaust gas back to the intake manifold of the engine. The gas is thereby combusted on multiple occasions before leaving the system. In addition, EGR systems can include a turbocharger to provide highly pressurized combustion gas to the engine.

A valve is typically employed to control the operation and the amount of exhaust gas permitted to recirculate in an EGR system. This permits operation of the system to change based on driving conditions and to balance engine efficiency and emissions. The valves that are used in EGR applications are subjected to extremely severe operating conditions, as they must operate over a large temperature range (typically −40° C.-800° C., sometimes up to 1000° C.) since the exhaust is extremely hot, and the exhaust contains corrosive and acidic materials. In addition, these valves must have very low leakage characteristics so that exhaust gas does not escape to the engine compartment or elsewhere.

Further still, the actuators used to control such valves typically do not have high accuracy. In addition, only a low amount of force can be applied if the valve is directly controlled by a solenoid. Therefore, a need exists for an improved actuator assembly.

### SUMMARY OF THE INVENTION

In some embodiments, the present invention provides an EGR system for an engine that includes an intake port in fluid communication with an intake manifold of the engine and an exhaust line in fluid communication with at least one exhaust manifold of the engine. The system also includes an exhaust gas recirculation conduit in fluid communication with the exhaust line and the intake port and a cooler fluidly positioned along the exhaust gas recirculation conduit and in fluid communication with the exhaust line and the intake port. A valve is fluidly positioned along the exhaust gas recirculation conduit and in fluid communication with the exhaust line and the intake port. The valve includes a housing having a valve passageway through which exhaust gases pass from a first end to a second end of the valve. The valve also includes an electronic solenoid controlled hydraulic actuator operable to control the valve, and the actuator includes a position feedback sensor to detect a position of the valve.

In some embodiments, the present invention provides a butterfly valve for controlling a gas stream in an engine. The butterfly valve includes a housing having a valve passageway through which exhaust gases pass from a first end to a second end of the valve. The valve passageway includes a shaft axis, bores on opposite sides of the passageway that are aligned along the shaft axis with one another, and lap seating surfaces on opposite sides of the passageway facing opposite ends of the valve, the shaft axis being between the lap seating surfaces. The butterfly valve also includes a butterfly valve element in the valve passageway between the bores, and a shaft extending between the bores and laterally through the butterfly valve element, the shaft also extending into bushings so as to journal the shaft relative to the housing. The butterfly valve also includes an actuator for controlling an angular position of the butterfly valve element. The actuator includes a hydraulic piston that rotates the butterfly valve element according to a linear position of the hydraulic piston, the linear position of the hydraulic piston being determined by a volume of hydraulic fluid on one side or an opposite side of the hydraulic piston. The actuator also includes an electronic solenoid valve that controls the volume of hydraulic fluid on each side of the hydraulic piston, and a position feedback sensor that produces a signal representative of the angular position of the butterfly valve element.

The foregoing and other objects and advantages of the invention will be apparent in the detailed description and drawings which follow. In the description, reference is made to the accompanying drawings which illustrate a preferred embodiment of the invention.

### BRIEF DESCRIPTION OF THE DRAWINGS

FIG. 1a is a schematic representation of an EGR system according to the present invention;

FIG. 1b is a schematic representation of an EGR series-sequential turbocharger system according to the present invention;

FIG. 1c is a schematic representation of valve assemblies according to the present invention;

FIG. 2 is a perspective view of a valve assembly incorporating the invention;

FIG. 3 is an exploded perspective of the valve assembly of FIG. 2;

FIG. 4 is a perspective sectional view of the valve assembly from the line 4-4 of FIG. 2 with a solenoid valve removed;

FIG. 5 is a perspective sectional view of an actuator housing from the line 4-4 of FIG. 2 with the solenoid valve shown in full;

FIG. 6 is a side view of the section shown in FIG. 4;

FIG. 7 is a side view of the section shown in FIG. 5;

FIG. 8 is an end plan view of a butterfly valve of FIG. 2;

FIG. 9 is a cross-sectional view of the butterfly valve from the plane of the line 9-9 of FIG. 8;

FIG. 10 is a cross-sectional view of the butterfly valve from the plane of the line 10-10 of FIG. 8; and

FIG. 11 is a cross-sectional view of a butterfly valve with an alternative housing and bushing design.

### DETAILED DESCRIPTION OF THE PREFERRED EMBODIMENT

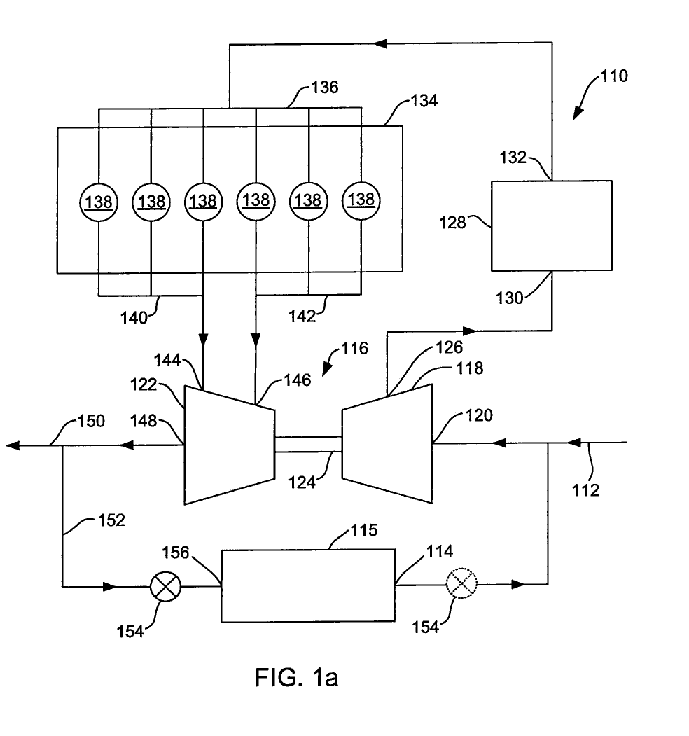

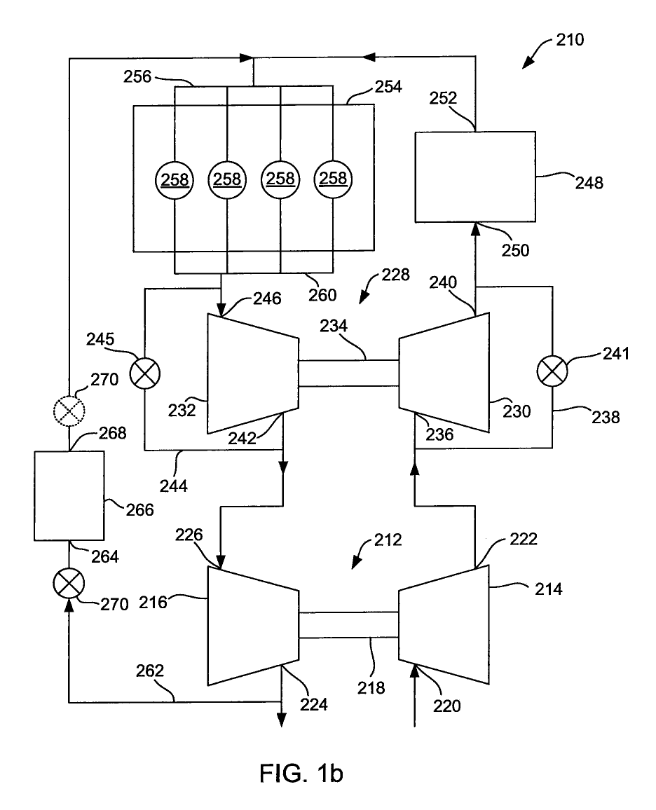

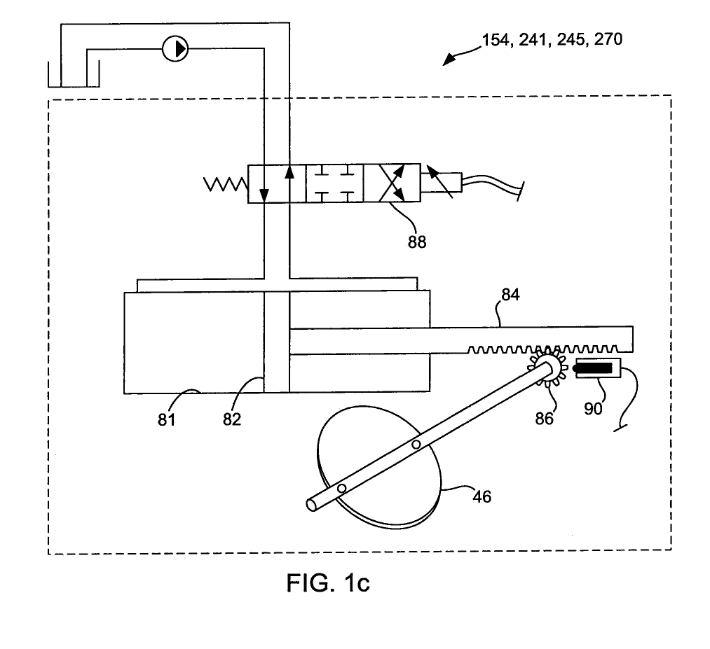

FIG. 1a shows a schematic representation of an exhaust gas recirculation (EGR) system 110. The system 110 includes an intake port 112 that may be in fluid communication with the air filter (not shown) of a vehicle. The intake port 112 fluidly communicates with an outlet 114 of a cooler 115. The cooler 115 may be any type of cooler commonly used in this type of system. The intake port 112 also fluidly communicates with a turbocharger 116. Specifically, the intake port 112 fluidly communicates with the inlet 120 of a compressor 118 of the turbocharger 116. The turbocharger 116 also includes a turbine 122 rotatably coupled to the compressor 118 by a shaft 124. An outlet 126 of the compressor 118 fluidly communicates with an inlet 130 of a cooler 128. The cooler 128 may be any type of cooler commonly used to cool gases from the compressor of a turbocharger. An outlet 132 of the cooler 128 fluidly communicates with the intake manifold 136 of an engine block 134. The engine block includes a plurality of combustion cylinders 138. Six combustion cylinders 138 are illustrated in this system. However, those skilled in the art will recognize appropriate changes to apply the present invention to an engine with any number or configuration of combustion cylinders. Three of the combustion cylinders 138 fluidly communicate with a first exhaust manifold 140. The remaining cylinders 138 fluidly communicate with a second exhaust manifold 142. The first and second exhaust manifolds 140 and 142 fluidly communicate with inlets 144 and 146, respectively, of the turbine 122. An outlet 148 of the turbine 122 fluidly communicates with the exhaust line 150 and an EGR conduit 152. The EGR conduit 152 fluidly communicates with an inlet 156 of the cooler 115 through an EGR valve 154, thereby providing a hot-side EGR valve. The EGR valve 154 is preferably a butterfly valve as discussed below.

It should be understood that the EGR system 110 shown in FIG. 1a can be modified. For example, an EGR system can be constructed in which the turbocharger 116 is not included. In addition, the outlet 114 of the cooler 115 may fluidly communicate with the intake port 112 through the EGR valve 154, thereby providing a cold-side EGR valve.

FIG. 1b shows a schematic representation of a series sequential turbocharger system 210. The system includes a low pressure turbocharger 212 having a low pressure compressor 214 and a low pressure turbine 216. A shaft 218 rotatably connects the low pressure compressor 214 and the low pressure turbine 216. The low pressure compressor 214 includes an inlet 220 that preferably fluidly communicates with the air filter (not shown) of the vehicle. The low pressure compressor 214 also includes an outlet 222 that fluidly communicates with other components of the system 210, as described below. The low pressure turbine 216 includes an outlet 224 that preferably fluidly communicates with the exhaust line (not shown) of the vehicle. The low pressure turbine 216 also includes an inlet 226 that fluidly communicates with other components of the system 210, as described below.

The system 210 includes a high pressure turbocharger 228 having a high pressure compressor 230 and a high pressure turbine 232. A shaft 234 rotatably connects the high pressure compressor 230 and the high pressure turbine 232. The high pressure compressor 230 includes an inlet 236 that fluidly communicates with the outlet 222 of the low pressure compressor 214 and a compressor bypass conduit 238. The high pressure compressor 230 also includes an outlet 240 that fluidly communicates with the compressor bypass conduit 238. It should be noted that a compressor bypass valve 241 is located on the compressor bypass conduit 238 separating the ends connecting to the inlet 236 and the outlet 240 of the high pressure compressor 230. The compressor bypass valve 241 is preferably a butterfly valve as discussed below. The high pressure turbine 232 includes an outlet 242 that fluidly communicates with the inlet 226 of the low pressure turbine 216 and a turbine bypass conduit 244. The high pressure turbine 232 also includes an inlet 246 that fluidly communicates with the turbine bypass conduit 244. It should be noted that a turbine bypass valve 245 is located on the turbine bypass conduit 244 separating the ends connecting to the inlet 246 and the outlet 242 of the high pressure turbine 232. The turbine bypass valve 245 is also preferably a butterfly valve as discussed below.

The outlet 240 of the high pressure compressor 230 and the compressor bypass conduit 238 fluidly communicate with an inlet 250 of a charge air cooler 248. An outlet 252 of the charge air cooler 248 fluidly communicates with an intake manifold 256 of an engine block 254. The engine block 254 includes a plurality of combustion cylinders 258. Four combustion cylinders 258 are included in this system. However, those skilled in the art will recognize appropriate changes to apply the present invention to an engine with any number or configuration of combustion cylinders. The engine block 254 also includes an exhaust manifold 260 that fluidly communicates with the inlet 246 of the high pressure turbine 232 and the turbine bypass conduit 244. The intake manifold 256 and the outlet 224 of the low pressure turbine 216 fluidly communicate through an EGR conduit 262. The EGR conduit 262 fluidly communicates with an inlet 264 of a cooler 266 through an EGR valve 270, thereby providing a hot-side EGR valve. Alternatively, an outlet 268 of the cooler 266 may fluidly communicate with the intake manifold 256 through the EGR valve 270, thereby providing a cold-side EGR valve. The EGR valve 270 is preferably a butterfly valve as discussed below.

Referring to FIG. 1c, a schematic of the valves 154, 241, 245 and 270 is shown. Each valve is connected to a pump that supplies hydraulic fluid and to a tank or reservoir that stores hydraulic fluid. The hydraulic circuit may also include other well-known components, such as filters and pilot-operated relief valves. Each of the valves 154, 241, 245 and 270 includes a three position, four way solenoid-controlled valve 88, a hydraulic actuator, and a butterfly valve element 46. The solenoid-controlled valve 88 is preferably a spring return valve that is normally in the position shown in FIG. 1c. The normal position of the solenoid-controlled valve 88 results in the butterfly valve element 46 being normally closed as described below. The solenoid-controlled valve 88 is preferably selectively actuated with a pulse-width modulation signal.

The hydraulic actuator is in fluid communication with the pump and the tank through the solenoid-controlled valve 88. The hydraulic actuator includes an actuator chamber 81, a piston 82, and a rack 84. The actuator chamber 81 receives hydraulic fluid and moves the piston 82 depending on which part of the chamber is coupled to the pump. The piston 82 and the rack 84 of the hydraulic actuator are preferably normally extended due to the normal position of the solenoid-controlled valve 88. The solenoid-controlled valve 88 is selectively actuated to pressurize the rod side of the actuator chamber 81 to vary the position of the piston 82 and the rack 84.

The butterfly valve element 46 is as described below and connects to a pinion 86. The pinion 86 includes a plurality of teeth that engage teeth of the rack 84. Therefore, extension and retraction of the piston 82 and the rack 84 cause rotation of the pinion 86 and the butterfly valve element 46. The butterfly valve element 46 is preferably normally closed due to hydraulic pressure, and selectively actuating the solenoid-controlled valve 88 varies the opening of the butterfly valve element 46. A rotary position sensor 90 for providing feedback for controlling the position of the pinion 86 is also preferably provided.

The valves 154, 241, 245 and 270 are preferably valve assemblies 10 as described below. Although the valve assembly 10 is shown and described as a butterfly valve, the actuator assembly may be used to control any type of valve. For example, the actuator assembly may be used to control a rotational poppet valve, a stem valve, or any other valve that is well known in the art.

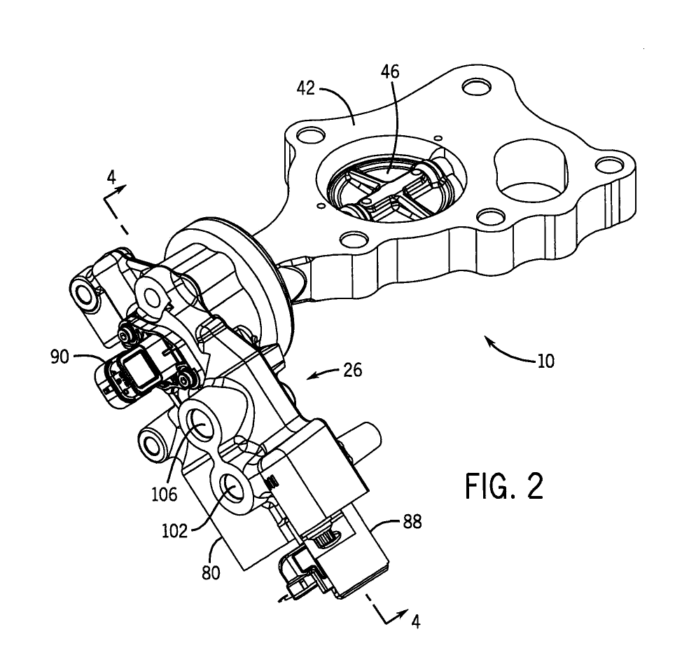

Referring to FIG. 2, a valve assembly 10 incorporates a butterfly valve element 46 located within a housing 42. The physical design of the housing 42 may be modified depending on the shapes of the EGR conduits and the position of the valve within the system. The valve assembly 10 has a shaft 22 affixed to the butterfly valve element 46 inside the valve assembly 10 as described below. An electro-hydraulic actuator assembly 26 is pressure operated to adjust the angular position of the shaft 22, and therefore, as discussed above, the butterfly valve element 46 according to the pressure exerted on the actuator assembly 26.

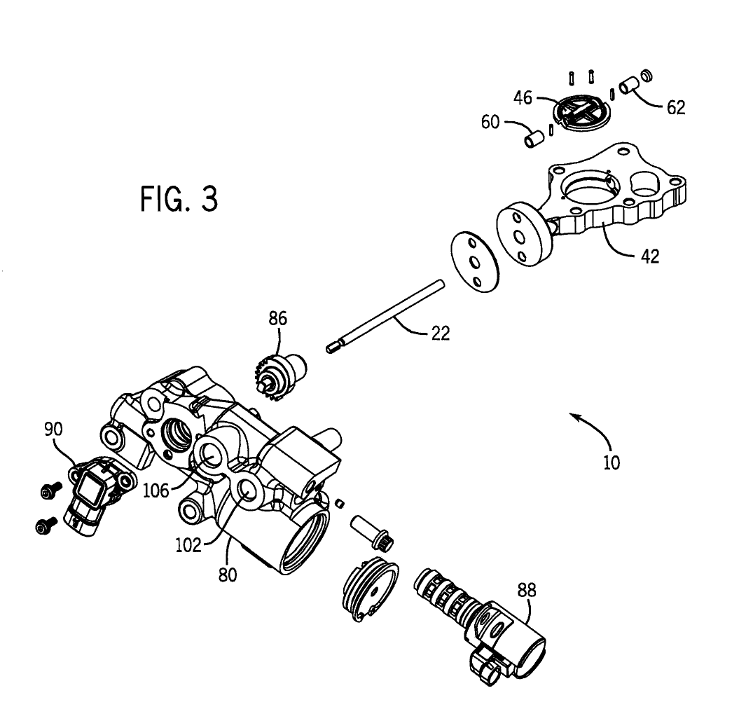

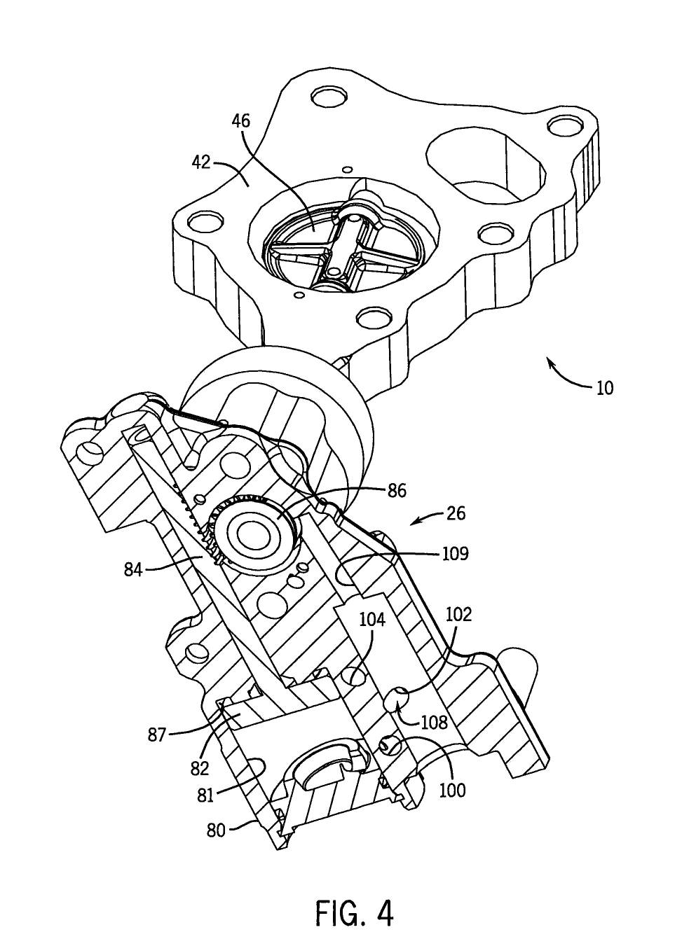

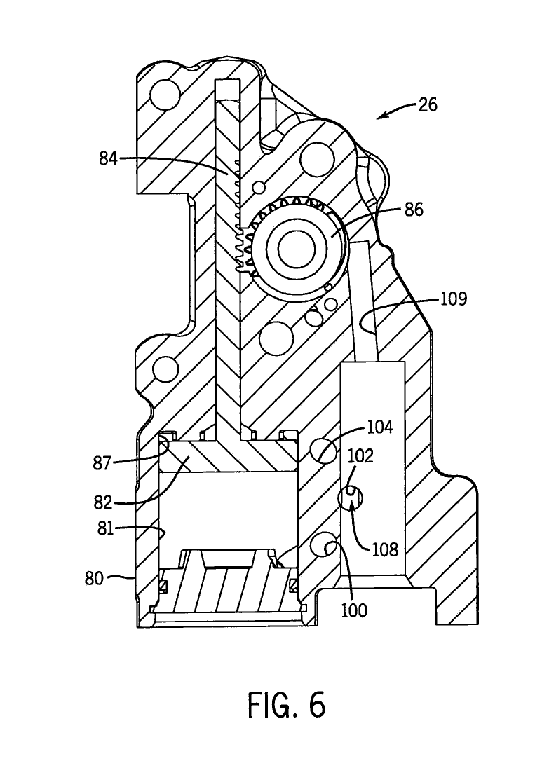

Referring to FIGS. 2-7, the electro-hydraulic actuator assembly 26 is preferably a high torque, high resolution actuator that includes an actuator housing 80 that defines a variable volume pressurized fluid actuator chamber 81 and encloses the piston 82 connected to the rack 84. The actuator chamber 81 is preferably fed by the same pressurized fluid system that feeds bearings of the turbocharger. This may be the pressurized engine oil lubrication system, for example. With such a system the pressure varies with engine speed. However, the actuator assembly 26 may use other fluids besides hydraulic fluids. The rack 84 translates linearly inside the actuator housing 80 to rotate the pinion 86, as discussed above. The pinion 86 is rotatably fixed to the shaft 22 and therefore the butterfly valve element 46. The orientation of the butterfly valve element 46, and therefore the degree of opening, is varied by actuation of the piston 82.

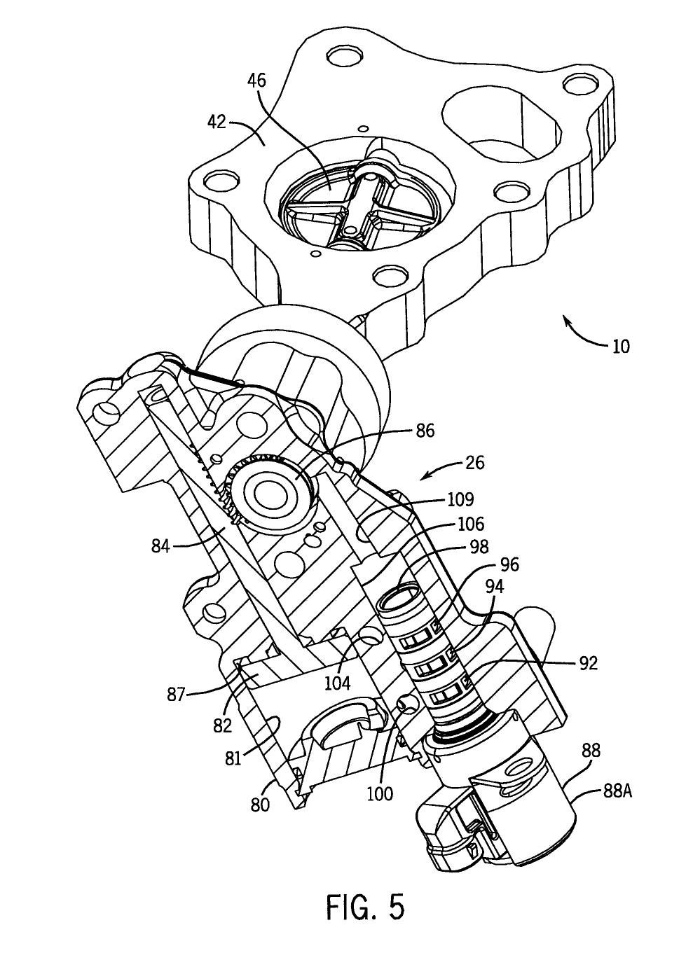

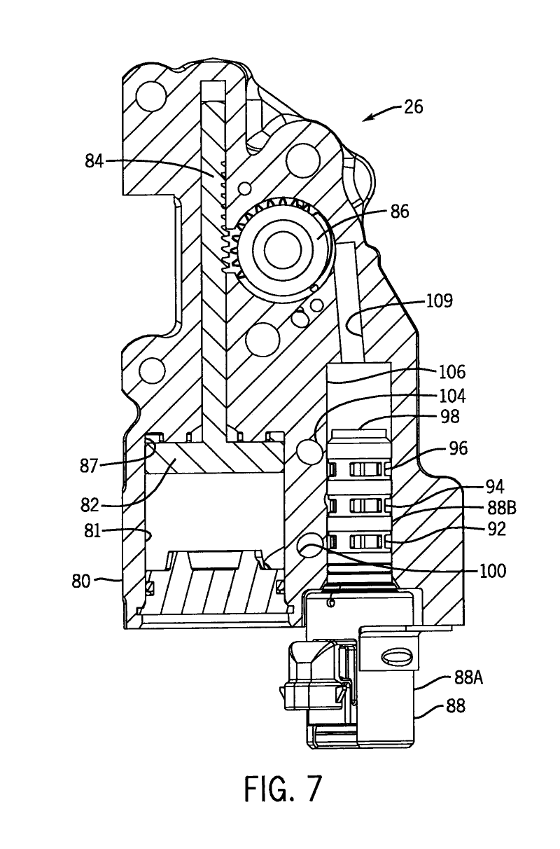

The electro-hydraulic actuator assembly 26 also preferably includes a cartridge-type solenoid-controlled valve 88 to control the amount of hydraulic fluid supplied to the actuator chamber 81. Referring to FIGS. 5 and 7, a port section 88B of the solenoid valve 88 includes multiple ports, including bore port 92, pump port 94, rod port 96, and tank port 98. Accordingly, referring to FIGS. 2-4 and 6, the actuator housing 80 includes multiple passageways corresponding to the ports of the solenoid valve 88, including bore passageway 100, pump passageway 102, rod passageway 104, and tank passageway 106. Normally the bore passageway 100 is connected to the pump passageway 102 and the rod passageway 104 is connected to the tank passageway 106 through the ports of the solenoid valve 88. This holds the butterfly valve element 46 in the normally closed position. Actuation of the solenoid valve 88 changes the port connections, and therefore the bore passageway 100 connects to the tank passageway 106 and the rod passageway 104 connects to the pump passageway 102. This moves the butterfly valve element 46 to an open position.

In addition, the actuator housing 80 includes drain line passageway 108 and a gear cavity passageway 109. The drain line passageway 108 is in fluid communication with the pump passageway 102 and the housing cavity in which the rack 84 and pinion 86 engage one another. The gear cavity passageway 109 is in fluid communication with the tank passageway 106 and the housing cavity in which the rack 84 and pinion 86 engage one another. This provides lubrication to the rack 84 and the pinion 86. However, the resistance to flow along these passageways is preferably relatively high so that all hydraulic fluid does not flow from directly from pump back to tank; that is, a relatively low resistance to flow along these passageways would prevent the hydraulic fluid from moving the piston 82.

The amount of hydraulic fluid supplied to the actuator chamber 81 may be varied, for example, according to engine speed. The electro-magnetic solenoid valve 88 is preferably pulse width modulation (PWM) controlled, as discussed above. The electro-hydraulic actuator assembly 26 also preferably includes the rotary position feedback sensor 90 to monitor and control the angular orientation of the butterfly valve element 46 in a closed-loop manner. The rotary position feedback sensor 90 may be a hall effect sensor on the pinion shaft. The rotary position feedback sensor 90 is preferably sealed within a compartment of the actuator housing 80 for protection from the hydraulic fluid.

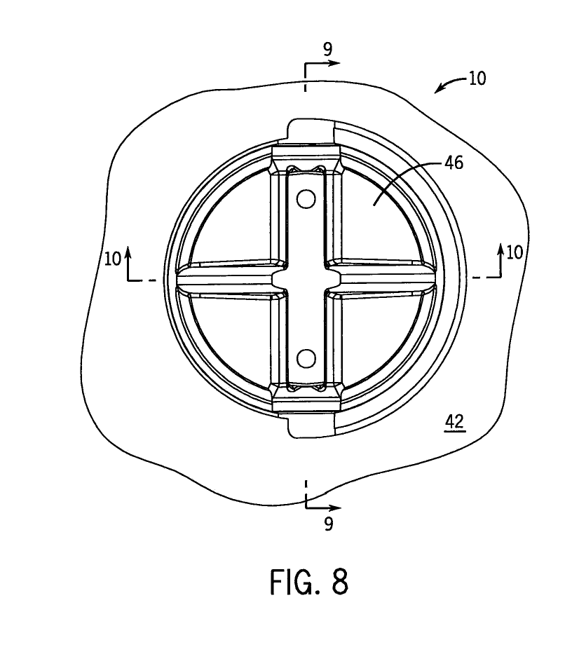

Referring to FIGS. 8-10, the internal construction the housing 42 is shown. The housing 42 includes a valve passageway 44 that extends from one end of the housing 42 to the other. The butterfly valve element 46 that is positioned in the passageway 44 is generally circular and can be rotated about the axis 58 of shaft 22 so that it is either blocking the passageway 44, or allowing passage of gas through the passageway 44 in varying amounts. When it is fully open, the butterfly valve element 46 is oriented in a plane that is substantially perpendicular to the plane in which it lies in FIGS. 8-10, which is the closed position, so that when open substantially only its thickness dimension is presented to the flow of gas in the passageway. As such, the flow of gas can pass the butterfly valve element 46 on both sides of it and since the shaft is in the middle of the valve, the valve is generally balanced by the stream of gas. When the butterfly valve element 46 is closed (FIGS. 8-10), it seats against lap seating surfaces 48 and 50 that are formed in the passageway on the housing on opposite sides of the passageway and facing opposite ends of the valve. The axis 58 about which the butterfly valve element 46 is turned is between the two lap seating surfaces 48 and 50, and is the axis of shaft 22. Pressurizing the bore side 81 of the actuator 80 closes the butterfly valve element 46 and pressurizing the rod side 87 of the actuator 80 opens the butterfly valve element 46.

Shaft 22 extends into bores 54 and 56 on opposite sides of the passageway 44, which are also aligned along the shaft axis 58. Bushings 60 and 62 are pressed into the respective bores 54 and 56 such that they do not turn relative to the housing 42 and are fixed along the axis 58 relative thereto. The bushings 60 and 62 journal the shaft 22 and also extend into butterfly counter bores 66 and 68 that are formed in opposite ends of the bore through the butterfly valve element 46 through which the shaft 22 extends. Pins 70 keep the butterfly valve element 46 from turning too much relative to the shaft 22, as they are pressed into holes in the shaft 22. The holes in the butterfly valve element 46 through which the pins 70 extend may be slightly larger than the pins 70 so they do not form a fixed connection with the butterfly element 46, so as to permit it some freedom of relative movement. Thus, the butterfly 46 can, to a limited extent, turn slightly relative to the shaft 22, and move along the axis 58 relative to the shaft 22, limited by the pins 70 and the other fits described herein.

A cap 74 is preferably pressed into the bore 56, to close off that end of the assembly. The shaft 22 extends from the opposite end, out of bore 54, so that it can be coupled to an actuator, for example like the actuator assembly 26. A seal pack (not shown) can be provided between the shaft 22 and the bore 54 to inhibit leakage into or out of the valve, and a backer ring (not shown) may be pressed into the bore 54 to hold in the seal pack. The lap seating surfaces 48 and 50 are actually spaced by approximately the thickness of the butterfly valve element 46 and seal against the butterfly valve element 46 on their respective sides of the axis 58. In order to form these seals, the butterfly valve element 46 must be free to lay flat against the lap seating surfaces in the closed position of the valve. That is nearly impossible to do unless there is sufficient clearance built into the rotary joints that mount the butterfly valve element. The problem is that too much tolerance results in a leaky valve.

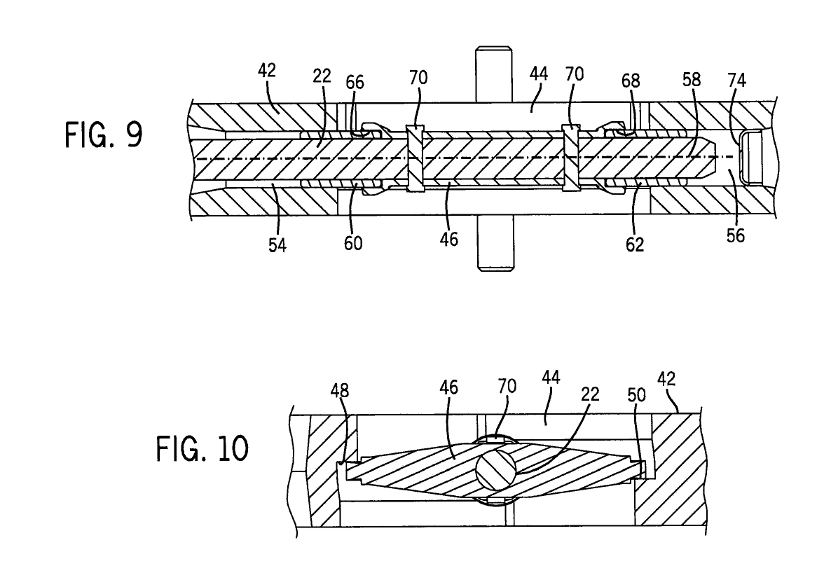

There is one slip fit between the bushings 60, 62 and their respective counter bores 68, 66, and there is another slip fit between the shaft 22 and the bushings 60, 62. It has been found that the leakage through the valve passageway 44 can be best controlled by making one of these fits a close running fit, and the other of these fits a medium or loose running fit. It is somewhat preferable to make the bushing-to-counter bore fit a close fit and the shaft-to-bushing fit the looser fit because providing the looser fit at the smaller diameter results in less overall leakage. However, either possibility has been found acceptable. In addition, as shown in FIG. 9, the bushing-to-counter bore interface is preferably shorter than the shaft-to-bushing interface. Providing the bushing-to-counter bore interface as a close fit and a short interface reduces leakage and permits the butterfly valve element 46 to move to a limited extent relative to the bushings 60 and 62 and the shaft 22 so that the butterfly valve element 46 seats flatly against the housing 42.

Choice of materials has also been found important to reduce the hysteresis of the valve. In addition, sets of materials can be selected based on the temperature range of the application. For example, an operating temperature above 850° C. may correspond to one set of materials and an operating range between 850° C.-750° C. may correspond to another set of materials. It should also be recognized that similar materials may gall under high temperature and pressure. As such, the materials for the components of the butterfly valve 40 are preferably as follows: the housing 42 is cast steel or an HK30 austenitic stainless steel alloy, the butterfly valve element 46 is cast steel, the shaft 22 is stainless steel and the bushings 60 and 62 are a steel that is compatible with the operating temperature and coefficient of thermal expansion of the other materials. If the valve assembly 10 is used as a turbine bypass valve 145, the shaft 22 and the butterfly valve element 46 may be stainless steel, the bushings 60 and 62 may be a cobalt/steel alloy, such as Tribaloy. Some applications may not require these materials or different combinations of these materials. For example, if the butterfly valve 40 is to be used in a low temperature application, the housing 42 may be high silicon molybdenum steel.

In an actual example, the fit of the bushings 60 and 62 to the counter bores 68 and 66 is that the OD of the bushings 60 and 62 is preferably 12.500 mm +0.000 −0.011 mm and the ID of the counter bores 68 and 66 is preferably 12.507 mm +0.000 −0.005 mm. These dimensions provide a maximum material condition of 0.002 mm. In the same application, the OD of the shaft is preferably in the range of 8.985 mm +0.000 −0.015 mm and the ID of the bushing 60 and 62 is preferably in the range of 9.120 mm ±0.015 mm. These dimensions provide a maximum material condition of 0.020 mm.

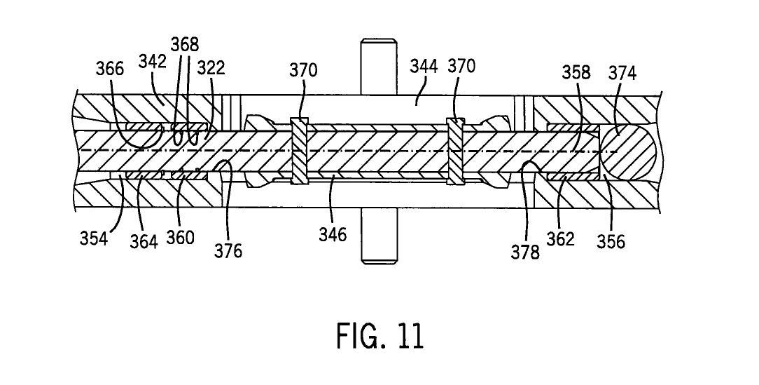

Referring to FIG. 11, an alternative embodiment for the housing, bushings, and butterfly valve element is shown. Like the first embodiment of the butterfly valve, the housing 342 includes a valve passageway 344, bores 354 and 356, and houses bushings 360 and 362, a shaft 322 with a longitudinal axis 358, a butterfly valve element 346 connected to the shaft 322 by pins 370, and a cap 374. However, several of the components of the alternative embodiment differ from those of the first embodiment of the butterfly valve. For example, the butterfly valve element 346 does not include counter bores. In addition, the bores 354 and 356 include reduced-diameter sections 376 and 378, respectively, that separate the bushings 360 and 362 from the valve passageway 344. The sections 376 and 378 create a shaft-to-housing interface. Further still, the bore 354 includes two bearings bushings 360 and 364 and rings 366 and 368 positioned on the shaft 322.

For the embodiment of the butterfly valve element shown in FIG. 11, the shaft-to-housing fit is preferably the looser fit and the shaft-to-bushing fit is preferably the close fit. Advantageously, the alternative embodiment of the butterfly valve does not have a leak path around the inner end of the bushings like the first embodiment of the butterfly valve. However, the first embodiment of the butterfly valve is less expensive and easier to manufacture than the alternative embodiment of the butterfly valve.

Use of the EGR system according to the present invention provides several advantages. For example, the butterfly valve design permits even force application at opening and closing of the valve over a broad range of temperatures in which it must function. This provides an EGR system with a high level of control and modulation of recirculated gases to help satisfy emissions, power, and fuel mileage requirements. Leakage of recirculated gases into the engine compartment is also reduced.

A preferred embodiment of the invention has been described in considerable detail. Many modifications and variations to the embodiment described will be apparent to those skilled in the art. Therefore, the invention should not be limited to the embodiment described, but should be defined by the claims which follow.

I claim:

1. An exhaust gas recirculation system for an engine, comprising:
an intake port in fluid communication with an intake manifold of the engine;
an exhaust line in fluid communication with at least one exhaust manifold of the engine;
an exhaust gas recirculation conduit in fluid communication with the exhaust line and the intake port;
a cooler fluidly positioned along the exhaust gas recirculation conduit and in fluid communication with the exhaust line and the intake port;
a valve fluidly positioned along the exhaust gas recirculation conduit and in fluid communication with the exhaust line and the intake port and including:
a housing having a valve passageway through which exhaust gases pass from a first end to a second end of the valve; and
an electronic solenoid controlled hydraulic actuator operable to control the valve, and the actuator including a position feedback sensor to detect a position of the valve.

2. The system of claim 1, wherein the actuator includes a hydraulic cylinder and the solenoid controls a hydraulic valve, and the hydraulic valve supplies hydraulic fluid to the hydraulic cylinder.

3. The system of claim 2, wherein the hydraulic cylinder includes a piston that moves a gear rack linearly.

4. The system of claim 3, wherein the gear rack rotates a pinion gear to change the position of the valve so as to vary a bypass flow rate at which the exhaust gases pass through the valve passageway.

5. The system of claim 4, wherein the valve rotated by the pinion gear is a butterfly valve.

6. The system of claim 1, wherein the sensor includes a hall effect rotary sensor to provide feedback for position control of a butterfly valve element.

7. The system of claim 1, wherein the solenoid valve is pulse width modulation controlled.

8. A butterfly valve for controlling a gas stream in an engine, comprising:
a housing having a valve passageway through which exhaust gases pass from a first end to a second end of the valve, the valve passageway including:
a shaft axis;
bores on opposite sides of the passageway that are aligned along the shaft axis with one another;
lap seating surfaces on opposite sides of the passageway facing opposite ends of the valve, the shaft axis being between the lap seating surfaces;
a butterfly valve element in the valve passageway between the bores;
a shaft extending between the bores and laterally through the butterfly valve element, the shaft also extending into bushings so as to journal the shaft relative to the housing;
an actuator for controlling an angular position of the butterfly valve element, the actuator including:
a hydraulic piston that rotates the butterfly valve element according to a linear position of the hydraulic piston, the linear position of the hydraulic piston being determined by a volume of hydraulic fluid on one side or an opposite side of the hydraulic piston;
an electronic solenoid valve that controls the volume of hydraulic fluid on each side of the hydraulic piston; and
a position feedback sensor that produces a signal representative of the angular position of the butterfly valve element.

9. The butterfly valve of claim 8, wherein the hydraulic piston includes a rod with a gear rack.

10. The butterfly valve of claim 9, wherein the gear rack rotates a pinion gear to change the position of the valve so as to vary a bypass flow rate at which the exhaust gases pass through the valve passageway.

11. The butterfly valve of claim 8, wherein the sensor includes a hall effect rotary sensor to provide feedback for position control of the butterfly valve element.

12. The butterfly valve of claim 8, wherein the solenoid valve is pulse width modulation controlled.

13. An exhaust gas recirculation system for an engine, comprising:
an intake port in fluid communication with an intake manifold of the engine;
an exhaust line in fluid communication with at least one exhaust manifold of the engine;
a turbocharger including:
a compressor having a compressor inlet and a compressor outlet, the compressor inlet being in fluid communication with the intake port and the compressor outlet being in fluid communication with the intake manifold of the engine;
a turbine having a turbine inlet and a turbine outlet, the turbine inlet being in fluid communication with the exhaust manifold of the engine and the turbine outlet being in fluid communication with the exhaust line;
an exhaust gas recirculation conduit in fluid communication with the exhaust line and the intake port;
a cooler fluidly positioned along the exhaust gas recirculation conduit and in fluid communication with the exhaust line and the intake port;
a valve fluidly positioned along the exhaust gas recirculation conduit and in fluid communication with the exhaust line and the intake port and including:
a housing having a valve passageway through which exhaust gases pass from a first end to a second end of the valve; and
an electronic solenoid controlled hydraulic actuator operable to control the valve, and the actuator including a position feedback sensor to detect a position of the valve.

14. The system of claim 13, wherein the actuator includes a hydraulic cylinder and the solenoid controls a hydraulic valve, and the hydraulic valve supplies hydraulic fluid to the hydraulic cylinder.

15. The system of claim 14, wherein the hydraulic cylinder includes a piston that moves a gear rack linearly.

16. The system of claim 15, wherein the gear rack rotates a pinion gear to change the position of the valve so as to vary a bypass flow rate at which the exhaust gases pass through the valve passageway.

17. The system of claim 16, wherein the valve rotated by the pinion gear is a butterfly valve.

18. The system of claim 13, wherein the sensor includes a hall effect rotary sensor to provide feedback for position control of a butterfly valve element.

19. The system of claim 13, wherein the solenoid valve is pulse width modulation controlled.
